(19) United States
(12) Patent Application Publication
(10) Pub. No.: US 2004/0235430 A1
(43) Pub. Date: Nov. 25, 2004

(54) Mobile phone and scent dispenser thereof

(75) Inventors: Kuo-Tong Ma, Taipei (TW); Ming-Chung Peng, Taoyuan (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/847,501

(22) Filed: May 17, 2004

(30) Foreign Application Priority Data
May 23, 2003 (TW) TW92113972

(51) Int. Cl. H04B 1/38

(52) U.S. Cl. 455/90.1; 455/90.3; 455/575.1

(57) ABSTRACT

A mobile phone and a scent dispenser thereof. The scent dispenser includes a body and a scent dispersing device. The body includes a tank and a channel. The tank stores a scent in liquid medium therein. The channel communicates the tank and the exterior, and includes a hydrophobic wall for preventing the scent in the tank from flowing to the exterior. The scent dispersing device is disposed in the body, and evaporates the scent so that the scent is dispersed to the exterior. The mobile phone includes a housing, the scent dispenser, and a controller. The scent dispenser and the controller are disposed in the housing, and the controller controls the scent dispersing device in the scent dispenser.

### BACKGROUND OF THE INVENTION

1. Field of the Invention

The invention relates to an electronic device, a mobile phone and a scent dispenser thereof, and in particular, the invention relates to a scent dispenser that can effectively disperse its scent.

2. Description of the Related Art

Normally, an incoming call to a mobile phone is indicated by visual, audible, or tactile notifications. Unfortunately, the feelings between people during contact cannot be transmitted via the mobile phone. Moreover, the conventional mobile phone is not provided with a function for relaxing or healing people.

Specifically, when the incoming call is received, the inventor wishes that the receiver can smell the personal aroma of the caller or the scent of the location around the caller, such as ocean, forest, or restaurant. That is, the receiver can smell the caller to enhance meaningful communications. Additionally, the inventor wishes to add an absorbent type drug or a drug for relaxing people to be dispersed during a call. Thus, the value of the mobile phone can be enhanced, and the mobile phone becomes a healthful product.

Recently, a mobile phone provided a scent dispenser has been introduced. However, since the scent dispenser is not built into the mobile phone, the structure is complicated, expensive, and not well suited for mass production.

Additionally, to reduce cost, a mobile phone with integral scent dispenser of a simplified structure is provided. In practice, however, it is difficult to effectively control scent dispersal.

### SUMMARY OF THE INVENTION

In view of this, the invention provides a scent dispenser that can effectively disperse its scent using a simplified structure at a low cost.

Another purpose of the invention is to provide a mobile phone that can disperse scent.

Still another purpose of the invention is to provide an electronic device with built-in scent dispenser.

Accordingly, the invention provides a scent dispenser including a body and a scent dispersing device. The body includes an exterior, a tank and a first channel. The tank stores a scent in liquid medium therein. The first channel communicates the tank and the exterior, and includes a hydrophobic inner wall for preventing the scent in the tank from flowing to the exterior. The scent dispersing device is disposed in the body, and evaporates the scent so that the scent is dispersed to the exterior.

In one embodiment, the body includes a second channel communicating the tank and the first channel. The second channel includes a hydrophilic inner wall for guiding the scent in a predetermined direction. The scent dispersing device is disposed on the second channel.

In another embodiment, the hydrophilic inner wall of the second channel includes a hydrophilic surfactant coating. Alternatively, the hydrophilic inner wall of the second channel can be hydrophobic material processed by O₂ plasma. It is noted that the hydrophobic material can be PDMS, PMMA, or PC.

In yet another embodiment, the body includes an air supply channel, communicating the tank and the exterior, for balancing the pressure differential therebetween. Also, the body is formed with an exit communicating with the first channel and the air supply channel.

In still another embodiment, the first channel is made of hydrophobic material to form the hydrophobic inner wall. The hydrophobic material is PDMS, PMMA, or PC. Alternatively, the first channel is covered with hydrophobic material to form the hydrophobic inner wall. The hydrophobic material is Teflon with a nano-surface or TiO₂ with a nano-surface.

In another embodiment, the scent dispersing device is a thermal resistance heater, a thermobubble droplet jet head, a liquid droplet jet head, a valve, or a shutter.

In another embodiment, the scent dispenser further includes a sensor for detecting an amount of the scent remaining in the tank. The sensor is electrical, optical, or a resistor.

In the invention, another scent dispenser is provided. The scent dispenser includes a body, a deformable elastic member, and a scent dispersing device. The deformable elastic member is disposed in the body, and maintains back pressure and stores a scent in liquid medium therein. The scent dispersing device is disposed in the body, and evaporates the scent so that the scent is dispersed to the exterior.

It is noted that the deformable elastic member is foam, porous material, an elastic sheet, or a spring.

In the invention, a mobile phone is provided. The mobile phone includes a housing, a scent dispenser, and a controller. The scent dispenser is disposed in the housing, and includes a body and a scent dispersing device. The body includes a tank and a first channel. The tank stores a scent in liquid medium therein. The first channel communicates the tank and the exterior, and includes a hydrophobic inner wall for preventing the scent in the tank from flowing to the exterior. The scent dispersing device is disposed in the body, and evaporates the scent so that the scent is dispersed to the exterior. The controller is disposed in the housing, and controls the scent dispenser.

In one embodiment, the scent dispenser is disposed in the housing in a removeable manner. The housing includes a protrusion, and the body is formed with a concave portion corresponding to the protrusion. The scent dispenser can thus be positioned in the housing.

In another embodiment, the scent dispenser further includes a signal transmitting device coupled to the controller to transmit a signal to or receive a signal from the controller. The controller includes a first pad, and the signal transmitting device includes a second pad corresponding to the first pad. Thus, the scent dispenser is coupled to the controller.

In another embodiment, the signal transmitting device is coupled to the scent dispersing device, which the controller actuates via the signal transmitting device to adjust the amount of the scent dispersed. More than one scent dispenser is provided, from which the controller selectively actuates dispersal of different scents.

In the invention, another mobile phone is provided. The mobile phone includes a housing, an scent dispenser, and a controller. The scent dispenser is disposed in the housing, and includes a body, a deformable elastic member, and a scent dispersing device. The deformable elastic member is disposed in the body, and maintains back pressure and stores a scent in liquid medium therein. The scent dispersing device is disposed in the body, and evaporates the scent so that the scent is dispersed to the exterior. The controller is disposed in the housing, and controls the scent dispenser.

In the invention, an electronic device is provided. The electronic device includes a housing, a scent dispenser, and a switch. The scent dispenser is disposed in the housing, and includes a body and a scent dispersing device. The body includes a tank and a first channel. The tank stores a scent in liquid medium therein. The first channel communicates the tank and the exterior, and includes a hydrophobic inner wall for preventing the scent in the tank from flowing to the exterior. The scent dispersing device is disposed in the body, and evaporates the scent so that the scent is dispersed to the exterior. The switch is disposed in the housing, and actuates the scent dispersing device.

In the invention, another electronic device is provided. The electronic device includes a housing, a scent dispenser, and a switch. The scent dispenser is disposed in the housing, and includes a body, a deformable elastic member, and a scent dispersing device. The deformable elastic member is disposed in the body, and maintains back pressure and stores a scent in liquid medium therein. The scent dispersing device is disposed in the body, and evaporates the scent so that the scent is dispersed to the exterior. The switch is disposed in the housing, and actuates the scent dispersing device.

### BRIEF DESCRIPTION OF THE DRAWINGS

The present invention can be more fully understood by reading the subsequent detailed description and examples with references made to the accompanying drawings, wherein:

FIGS. 1a-1b are schematic views of an scent dispenser as disclosed in a first embodiment of the invention;

FIGS. 2a-2b are schematic views of a first channel and a second channel in FIG. 1a;

FIGS. 3a-3c are schematic views of a sensor as disclosed in the invention;

FIGS. 4a-4b are schematic views of a mobile phone as disclosed in the invention;

FIG. 5 is a flowchart of a dispersing manner of the mobile phone in FIG. 4a; and

FIGS. 6a-6b are schematic views of an scent dispenser as disclosed in a second embodiment of the invention.

### DETAILED DESCRIPTION OF THE INVENTION

### First Embodiment

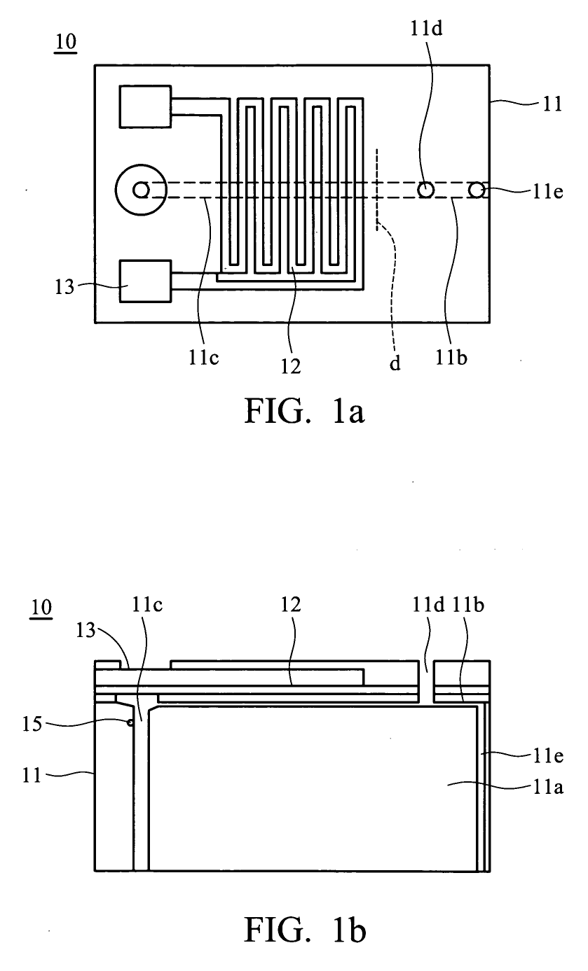

FIGS. 1a-1b show a scent dispenser 10 as disclosed in a first embodiment of the invention. In this embodiment, the scent dispenser 10 includes a body 11, a scent dispersing device 12, a signal transmitting device 13, and a sensor 15.

The body 11 is a basic component of the scent dispenser 10, and includes an exterior (not labeled), a tank 11a, a first channel 11b, a second channel 11c, an exit 11d, and an air supply channel 11e. As shown in FIG. 1b, the tank 11a is a hollow space in the body 11, and stores a scent in liquid medium 14 therein. It is noted that the first channel 11b and the second channel 11c are separated by a dotted line d in FIG. 1a.

The first channel 11b communicates with the tank 11a via the second channel 11c, and communicates with the exterior via the exit 11d. The first channel 11b includes a hydrophobic inner wall for preventing the scent 14 in the tank 11a from flowing to the exterior. It is understood that the first channel 11b may use hydrophobic material to form the hydrophobic inner wall.

The hydrophobic material may be PDMS (Polydimethylsiloxane), PMMA (Polymethymethacrylate), or PC (Polycarbonate).

Additionally, the first channel 11b may be coated with hydrophobic material to form the hydrophobic inner wall. The hydrophobic material is Teflon with a nano-surface or TiO₂ with a nano-surface. It is noted that TiO₂ is originally hydrophilic, and becomes hydrophobic after nano-treatment. Specifically, after TiO₂ is processed by nano-treatment, it consists of rough particles smaller than 100 nm. Thus, TiO₂ can be changed to hydrophobic from hydrophilic.

The second channel 11c and the air supply channel 11e, located in the tank 11a, are grooves formed on the inner wall of the body 11. The second channel 11c communicates the tank 11a and the first channel 11b. The second channel 11c includes a hydrophilic inner wall for guiding the scent 14 in a predetermined direction. It is understood that the hydrophilic inner wall of the second channel 11c may be formed by a hydrophilic surfactant coating. The surfactant may be Surfynol 440 manufactured by AIR PRODUCT, Tergitol 15-S-5 manufactured by UCC, or Tergitol XD-75 manufactured by UCC.

Additionally, the second channel may be made of hydrophobic material processed by O₂ plasma to create the hydrophilic inner wall. It is understood that the hydrophobic material may be PDMS, PMMA, or PC.

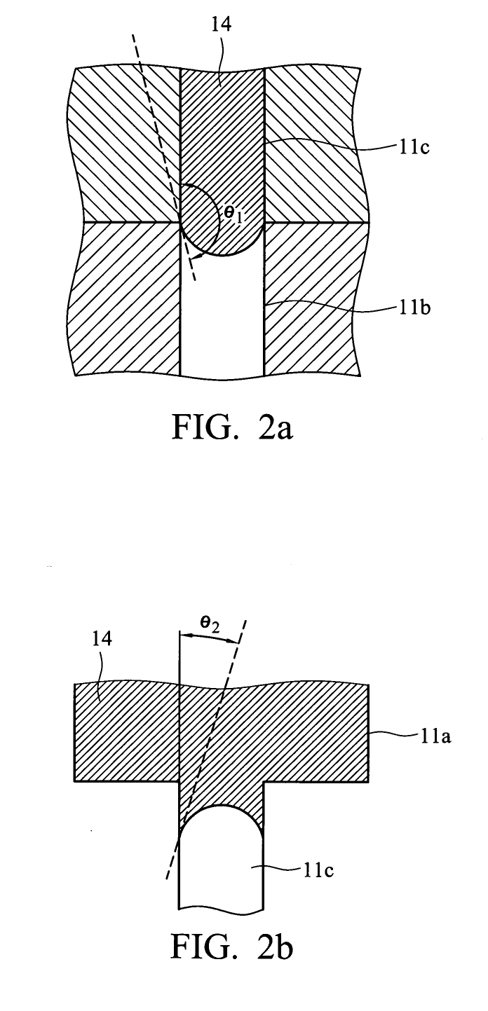

As stated above, the inner wall of the first channel 11b is hydrophobic, and the inner wall of the second channel 11c hydrophilic. A contact angle θ₁ between the first channel 11b and the scent 14 exceeds ninety degrees, as shown in FIG. 2a. A contact angle θ₂ between the second channel 11c and the scent 14 is less than ninety degrees, as shown in FIG. 2b.

Furthermore, a pressure differential ΔP, generated by the surface tension of the scent in the channel, can be derived by an equivalent radius r of the channel, the surface tension of the scent σ, and the contact angle θ, as follows.

ΔP=2σ(cosθ)/r

When the contact angle is less than ninety degrees, the pressure differential drives the scent in a predetermined direction via the second channel 11c. In contrast, when the contact angle is larger than ninety degrees, the pressure differential prevents the scent from flowing to the exterior via the first channel 11b. The surrounding air can enter the tank 11a via the air supply channel 11e to balance the pressure differential between the tank 11a and the exterior. Thus, by way of the special design of the channel, the scent is driven by the surface tension without the need for any additional driving means. As a result, the scent in the tank 11a is directly driven to the scent dispersing device 12 to be dispersed.

The air supply channel 11e communicates with the exterior via the exit 11d so as to admit the surrounding air to the tank 11a. Thus, the scent 14 in the tank 11a can flow along the second channel 11c. The exit 11d also communicates with the first channel 11b so that the evaporated scent 14 can be dispersed to the exterior via the exit 11d.

The scent dispersing device 12 is disposed in the body 11, and evaporates the scent 14 for dispersal to the exterior. As shown in FIG. 1a, the scent dispersing device 12 is located around the second channel 11c. Thus, when the scent dispersing device 12 is actuated, the scent 14 in the second channel 11c can be evaporated.

It is understood that the scent dispersing device 12 can be a thermal resistance heater, a thermobubble droplet jet head, a liquid droplet jet head, a valve, or a shutter. The thermal resistance heater can adjust the amount of the evaporated scent 14 by thermal energy to change the concentration. The thermobubble droplet jet head or the liquid droplet jet head can adjust the droplet amount of the scent 14 by its droplet jet head to adjust the concentration of the scent. The valve or shutter can adjust the amount of the scent by adjusting the number or size of openings to adjust the concentration of the scent.

The signal transmitting device 13 is coupled to the external device to transmit a signal to or receive a signal from the exterior as follows.

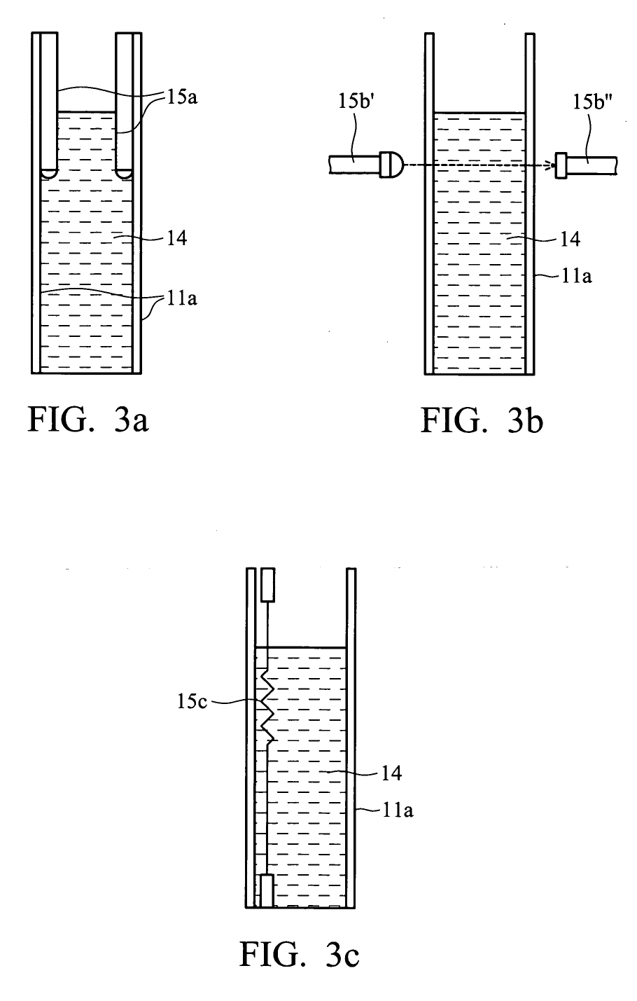

The sensor 15 detects a amount of the scent 14 remaining in the tank 11a. The sensor 15 may be an electrical type 15a as shown in FIG. 3a. Alternatively, the sensor 15b may be optical, including a light emitting diode 15b′ and a receiver 15b″ as shown in FIG. 3b. Additionally, the sensor 15c may be a resistor as shown in FIG. 3c. By way of the differential between the voltage or current of the sensor 15, the amount of the scent 14 remaining can be detected for timely refilling.

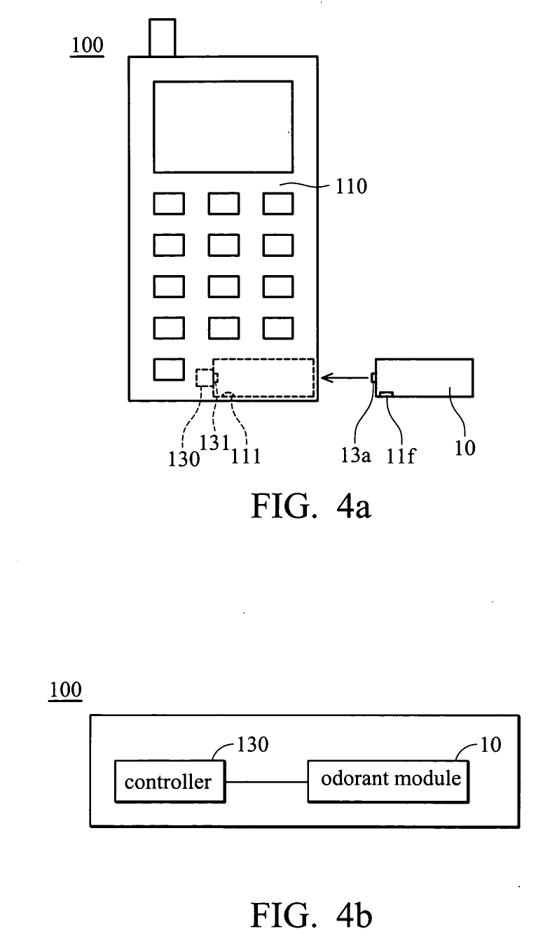

FIGS. 4a-4b show a mobile phone 100 with the scent dispenser 10. The mobile phone 100 includes a housing 110, the scent dispenser 10, and a controller 130. The housing 110 is a basic component of the mobile phone 100.

The scent dispenser 10, such as a cartridge, is disposed in the housing 110 in a detachable manner. As shown in FIG. 4a, the housing 110 is formed with a protrusion 111, and the body 11 of the scent dispenser 10 is formed with a concave portion 11f corresponding to the protrusion 111. Thus, the scent dispenser 10 can be positioned in the housing 110.

The controller 130 may be an original control chip disposed into the housing 110 of the mobile phone 100. By amending the program built in the control chip, the control chip can control the scent dispersing device 12 of the scent dispenser 10. For example, the controller 130 can perform load/save, program control, energy control, display, and preset functions. Specifically, the controller 130 has the following functions. By way of the keys (not labeled) on the mobile phone, the controller 130 can input, change, or save a function sequence. The battery (not shown) of the mobile phone enables the controller 130 to provide energy for dispersing scent. By way of the display (not labeled) on the mobile phone 100, the controller 130 can display information, such as whether the scent function is actuated or not. By the program built in the controller 130, the concentration of the scent can be adjusted as desired. The controller 130 can disperse different scents based on incoming calls, such as personalized for individual callers or originating locations can be preset in the mobile phone 100.

The controller 130 includes a first pad 131, and the signal transmitting device 13 of the scent dispenser 10 includes a second pad 13a corresponding to the first pad 131. Thus, the scent dispenser 10 can be coupled to the controller 130, and the signal transmitting device 13 of the scent dispenser 10 can transmit signals to or receive signals from the controller 130.

The signal transmitting device 13 of the scent dispenser 10 is also coupled to the scent dispersing device 12. Thus, the controller 130 actuates the scent dispersing device 12 via the signal transmitting device 13 to adjust the dispersing amount of the scent.

It is understood that the scent dispersing device 12 may include an original device, easily heated, in the mobile phone 100, such as a power amplifier to evaporate the scent by thermal energy. During dispersal, the power amplifier can be cooled.

The number of the scent dispensers 10 disposed in the mobile phone 100 may be more than one. The controller 130 can selectively actuate one or more of the scent dispensers 10 to disperse different scents or combinations thereof.

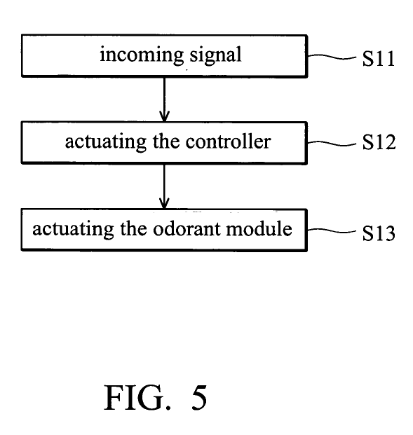

FIG. 5 is a flowchart of a dispersing process of the mobile phone 100. When an incoming signal is received by the mobile phone 100 as shown in step S11, the controller 130 is then actuated as shown in step S12. Finally, the controller 130 actuates the scent dispersing device 12 via the signal transmitting device 13 as shown in step S13 to disperse the scent.

As stated above, when the incoming call is received by the mobile phone, the user can smell the specific scent according to the caller by the controller and the scent dispenser. Thus, the feeling between people can be enhanced during communication.

Additionally, an absorbent drug or scent for healing or relaxing people can be built in the mobile phone so as to enhance the value thereof. Thus, the mobile phone may become a healthful product. Furthermore, according to the requirements of the user, the concentration, interval, or frequency of dispersal can be adjusted by the mobile phone. Moreover, different scents can be preset in the mobile phone, identifying callers or satisfying different users.

In the embodiment, by the hydrophilic/hydrophobic design of the channel in the scent dispenser, the scent can be driven by surface tension without additional driving means. Thus, the scent in the tank is directly driven to the scent dispersing device. As a result, structure is simplified, and costs are reduced.

While it is understood that the scent dispenser is applied herein to a mobile phone, the invention is not limited thereto. The scent dispenser can also accompany an electronic device with a control chip, such as a PDA or a notebook computer. Additionally, the invention can be disposed in an electronic device without the control chip as long as the electronic device includes a switch to actuate the scent dispenser.

### Second Embodiment

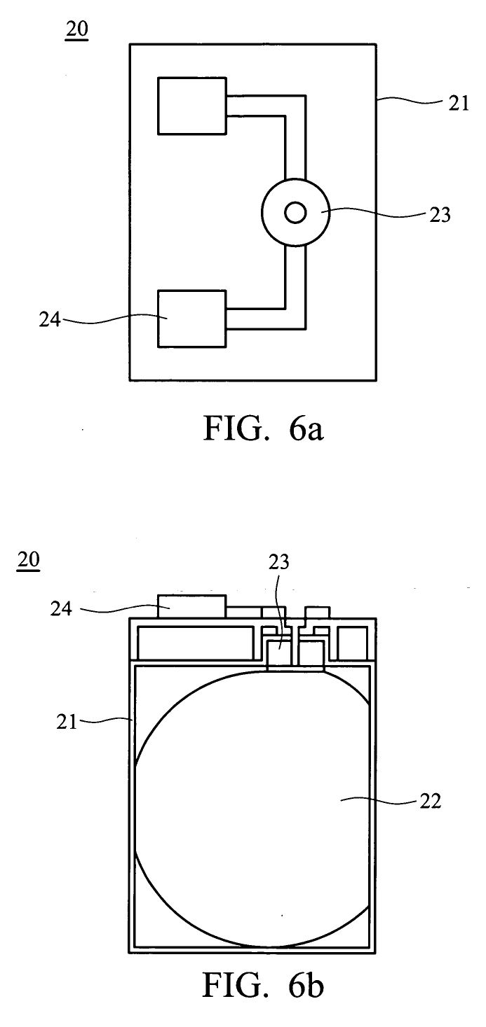

FIGS. 6a-6b show a scent dispenser 20 as disclosed in a second embodiment of the invention. In the embodiment, the scent dispenser 20 includes a body 21, a deformable elastic member 22, a scent dispersing device 23, and a signal transmitting device 24. Since the structures of the scent dispersing device 23 and the signal transmitting device 24 are the same as those of the scent dispersing device 12 and the signal transmitting device 13 in the first embodiment, their description is omitted here.

The body 21 is a basic component of the scent dispenser 20. The deformable elastic member 22 is disposed in the body 21, and maintains back pressure and stores a scent in liquid medium therein. It is understood that the deformable elastic member 22 may be foam, porous material, an elastic sheet, or a spring.

In the scent dispenser 20 of this embodiment, the deformable elastic member 22 prevents the scent in the elastic member 22 from flowing to the exterior via the opening of the body 21. By the scent dispersing device 23, the scent is dispersed to the surrounding area. Thus, structure is simplified, and costs are reduced.

It is understood that the scent dispenser of this embodiment can be applied in an electronic device such as a mobile phone. Also, the function of the first embodiment can be attained in this embodiment.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scent dispenser comprising:
a body including an exterior, a tank storing a scent in liquid medium therein, and a first channel communicating the tank and the exterior, wherein the first channel includes a hydrophobic inner wall for preventing the scent in the tank from flowing to the exterior; and
a scent dispersing device, disposed in the body, for evaporating the scent so that the scent is dispersed to the exterior.

2. The scent dispenser as claimed in claim 1, wherein the body includes a second channel communicating the tank and the first channel, and the second channel includes a hydrophilic inner wall guiding the scent in a predetermined direction.

3. The scent dispenser as claimed in claim 2, wherein the scent dispersing device is disposed on the second channel.

4. The scent dispenser as claimed in claim 2, wherein the hydrophilic inner wall of the second channel comprises a hydrophilic surfactant coating.

5. The scent dispenser as claimed in claim 2, wherein the hydrophilic inner wall of the second channel comprises hydrophobic material processed by O₂ plasma.

6. The scent dispenser as claimed in claim 5, wherein the hydrophobic material is PDMS, PMMA, or PC.

7. The scent dispenser as claimed in claim 1, wherein the body includes an air supply channel, communicating the tank and the exterior, for balancing the pressure differential between the tank and the exterior.

8. The scent dispenser as claimed in claim 7, wherein the body is formed with an exit communicating with the first channel and the air supply channel.

9. The scent dispenser as claimed in claim 1, wherein the first channel comprises hydrophobic material, constituting the hydrophobic inner wall.

10. The scent dispenser as claimed in claim 9, wherein the hydrophobic material is PDMS, PMMA, or PC.

11. The scent dispenser as claimed in claim 1, wherein the first channel comprises hydrophobic material, constituting the hydrophobic inner wall.

12. The scent dispenser as claimed in claim 11, wherein the hydrophobic material is Teflon with a nano-surface or TiO₂ with a nano-surface.

13. The scent dispenser as claimed in claim 1, wherein the scent dispersing device is a thermal resistance heater, a thermobubble droplet jet head, a liquid droplet jet head, a valve, or a shutter.

14. The scent dispenser as claimed in claim 1, further comprising a sensor detecting the amount of the scent remaining in the tank.

15. The scent dispenser as claimed in claim 14, wherein the sensor is electrical, optical, or a resistor.

16. A scent dispenser comprising:
a body;
a deformable elastic member, disposed in the body, maintaining back pressure and storing a scent in liquid medium therein; and
a scent dispersing device, disposed in the body, for evaporating the scent so that the scent is dispersed to the exterior.

17. The scent dispenser as claimed in claim 16, wherein the scent dispersing device is a thermal resistance heater, a thermobubble droplet jet head, a liquid droplet jet head, a valve, or a shutter.

18. The scent dispenser as claimed in claim 16, wherein the deformable elastic member is foam, porous material, an elastic sheet, or a spring.

19. The scent dispenser as claimed in claim 16, further comprising a sensor for detecting the amount of the scent remaining in the tank.

20. The scent dispenser as claimed in claim 19, wherein the sensor is electrical, optical, or a resistor.

21. An electronic device comprising:
a housing;
a scent dispenser, disposed in the housing, including a body and a scent dispersing device, wherein the body includes a tank and a first channel, the tank stores a scent in liquid medium therein, the first channel communicates the tank and the exterior and includes a hydrophobic inner wall for preventing the scent in the tank from flowing to the exterior, and the scent dispersing device is disposed in the body to evaporate the scent so that the scent is dispersed to the exterior; and
a controller, disposed in the housing, for controlling the scent dispersing device.

22. The electronic device as claimed in claim 21, wherein the scent dispenser is disposed in the housing in a detachable manner.

23. The electronic device as claimed in claim 21, wherein the housing includes a protrusion, and the body is formed with a concave portion corresponding to the protrusion, whereby the scent dispenser can be positioned in the housing.

24. The electronic device as claimed in claim 21, wherein the scent dispenser further includes a signal transmitting device coupled to the controller to receive a signal from the controller.

25. The electronic device as claimed in claim 24, wherein the controller includes a first pad, and the signal transmitting device includes a second pad corresponding to the first pad, whereby the scent dispenser is coupled to the controller.

26. The electronic device as claimed in claim 21, wherein the electronic device is a mobile phone.

27. The electronic device as claimed in claim 21, wherein the controller is a switch.

28. An electronic device comprising:
a housing;
a scent dispenser, disposed in the housing, including a body, a deformable elastic member, and a scent dispersing device, wherein the deformable elastic member is disposed in the body and maintains back pressure and stores a scent in liquid medium therein, and the scent dispersing device is disposed in the body and evaporates the scent so that the scent is dispersed to the exterior; and
a controller, disposed in the housing, for controlling the scent dispersing device.

29. The electronic device as claimed in claim 28, wherein the scent dispenser is disposed in the housing in a detachable manner.

30. The electronic device as claimed in claim 29, wherein the housing includes a protrusion, and the body is formed with a concave portion corresponding to the protrusion, whereby the scent dispenser can be positioned in the housing.

31. The electronic device as claimed in claim 28, wherein the scent dispenser further includes a signal transmitting device coupled to the controller to receive a signal from the controller.

32. The electronic device as claimed in claim 31, wherein the controller includes a first pad, and the signal transmitting device includes a second pad corresponding to the first pad, whereby the scent dispenser is coupled to the controller.

33. The electronic device as claimed in claim 28, wherein the electronic device is a mobile phone.

34. The electronic device as claimed in claim 28, wherein the controller is a switch.
